(19) United States
(12) Patent Application Publication
(10) Pub. No.: US 2004/0119757 A1
(43) Pub. Date: Jun. 24, 2004

(54) Apparatus and method for dynamically building a context sensitive composite icon with active icon components

(75) Inventors: Carole Rhoads Corley, Austin, TX (US); David Bruce Kumhyr, Austin, TX (US); Margaret Gardner MacPhail, Corpus Christi, TX (US)

Correspondence Address: Intellectual Property Law Dept., IBM Corporation, 11400 Burnet Road, Austin, TX, 78758, US

(73) Assignee: International Buisness Machines Corporation, Armonk, NY

(21) Appl. No.: 10/324,570

(22) Filed: Dec. 18, 2002

(51) Int. Cl. G09G 5/00

(52) U.S. Cl. 345/837

(57) ABSTRACT

A method and apparatus for dynamically building a context sensitive composite icon are provided. A base icon is used to represent a particular object in a graphical user interface. This base icon has addition points where icon additions may be attached to the base icon, such as by superimposing the icon additions over the base icon. By adding icon additions at the addition points of the base icon, a composite icon is generated and then registered with the graphical user interface. The icon additions that are used to generate the composite icon are selected based on a particular context in which the object associated with the base icon is being used. The use of icon additions with the base icon is determined dynamically as the context of the corresponding object changes. In this way, the same base icon may be used to represent a particular object with additions to the base icon being used to provide additional information that is important to the current context of the corresponding object. In a preferred embodiment, the icon additions are active and may be individually selectable apart from the base icon in order to provide additional functionality and/or information. In a specific example implementation of an embodiment, the base icon may be a shopping cart and the icon additions may be items selected for purchase. Both the base icon and the icon additions may be selected and thereby invoke associated data objects.

### RELATED APPLICATION

The present application is related to commonly assigned and co-pending U.S. patent application Ser. No. ______ (Attorney Docket No. AUS920020452US1) entitled “Apparatus and Method for Dynamically Building a Context Sensitive Composite Icon,” filed on even date herewith and hereby incorporated by reference.

### BACKGROUND OF THE INVENTION

1. Technical Field

The present invention is directed to a method and apparatus for dynamically building a context sensitive composite icon with active icon components. More specifically, the present invention provides a mechanism for dynamically displaying information in the form of a base icon and icon additions based on data associated with the base icon and a context in which the icon is being used wherein the icon additions are active so that they are individually selectable to perform functions and/or obtain information regarding the composite icon.

2. Description of Related Art

Icons are small, pictorial, on-screen representation of an object, such as a document, program, folder, disk drive, or the like, in a graphical user interface (GUI). Icons generally resemble some aspect of the object that they represent. In this way, the icon provides a minimal amount of information regarding the object with which it is associated.

FIG. 1 illustrates some exemplary known icons used in a Microsoft Windows™ operating environment. As shown in FIG. 1, the icon 110 is associated with the application used for setting and obtaining information about the network properties of the computer. The icon 110 represents two computers connected via a cable and thus, the graphical depiction provides information identifying the object with which it is associated. Similarly, the icon 120 is associated with an inbox application and graphically represents a physical inbox that would be present on a person's desk. Likewise, the icon 130 is associated with a recycling program and graphically represents a physical recycling trash can.

Typically, icon representations are defined long before they are used. That is, an application developer will define static icons that may be used to represent the object. The range of expression for an icon is limited with some being completely constant and some changing within a fixed set of representations. In other words, icons typically do not change or may be switched with other static replacement icons to give the impression that the icon has changed.

For example, the recycle bin icon 130 discussed above may have a first icon that graphically depicts an empty recycling bin when there are no files designated for recycling. When one or more files have been designated for recycling, however, the icon 130 may be switched to another static icon representing a full recycling bin, such as that depicted in FIG. 1.

Also, in order to provide entertainment value, animated icons are known to be used in which a series of static icons are quickly switched to give the illusion of movement within the icon. Such animated icons are available, for example, in Microsoft Windows Plus!™ and Icon Hear-It 98™, available from Moon Valley Software.

In addition, icon overlays, which are small images placed at the lower-left corner of the icon and represent a Shell object, are generally known in the art and are used to provide extra information regarding the object with which the icon is associated. For example, a commonly used icon overlay is the small arrow 150 that indicates that the icon represents a link, rather than the actual file or folder. In addition to the standard icon overlays, an application developer can generate custom icon overlays for specified Shell objects by implementing and registering an icon overlay handler. Information regarding icon overlays, some of which is reproduced herein below, may be obtained from Microsoft Corporation and the Microsoft Developer Network at http://msdn.microsoft.com/library/default.asp?url=/library/en-us/shellcc/platform/shell/programmersguide/shell_int/shell_int_extending/extensionhandlers/iconoverlay handlers.asp.

Icon overlay handlers are Component object Model (COM) objects that are associated with a particular icon overlay. All communication between the Shell and the handler takes place through the handler's IShellIconoverlayIdentifier interface. When the Shell starts up, it initializes all icon overlay handlers by calling two of their IShellIconOverlayIdentifier methods:

(1) the Shell calls GetOverlayInfo to request the location of the handler's icon overlay. The icon overlay handler returns the name of the file containing the overlay image, and its index within that file. The Shell then adds the icon overlay to the system image list; and

(2) the Shell calls GetPriority to determine the icon overlay's priority. The priority value is a number from zero to 100, with 100 indicating the lowest priority. If more than one icon overlay is requested for a particular file, the Shell uses this value to help it determine which icon overlay to display.

Before painting an object's icon, the Shell passes the object's name to each icon overlay handler's IsMemberOf method. An icon overlay handler is normally associated with a particular group of files. For example, the icon overlay handler might request an overlay for all members of a file class, such as all files with an myp file name extension. If a handler wants to have its icon overlay displayed, it returns S_OK. The Shell then calls the handler's GetOverlayInfo method to determine which icon to display.

It should be noted that once the image has been loaded into the system image list during initialization, it cannot be changed. After initialization, the file name and index are used only to identify the icon overlay. The system will not load a new icon overlay. When GetOverlayInfo is called, the handler must return the same file name and index that was specified when the function was first called.

Although only one icon overlay can be displayed, it is possible for an object to have icon overlays requested by more than one handler. In that case, the Shell resolves the conflict by displaying the highest priority icon overlay. The Shell resolves many such conflicts with an internal set of rules. If these rules are not sufficient, the Shell compares the priority values that were specified by the handlers' GetPriority method during initialization.

Thus, while icon overlays may be used in known systems to provide additional information about a shell object, these icon overlays are limited in that only a single icon overlay may be displayed, the icon overlay is limited to a single position on the original icon, and the icon overlay is fixed once the icon image has been loaded into the system image list. Furthermore, such icon overlays do not provide any information regarding the context in which the icon is being used. Rather, they merely provide a fixed representation of a shell object.

Thus, it would be beneficial to have an improved method and apparatus for dynamically building a context sensitive composite icon that is changeable based on the context in which the icon is used. It would further be beneficial to have a method and apparatus that dynamically builds context sensitive composite icons with additions that are active so that they may be individually selectable.

### SUMMARY OF THE INVENTION

The present invention provides a method and apparatus for dynamically building a context sensitive composite icon with active icon components. With the present invention, a base icon is used to represent a particular object in a graphical user interface. This base icon has addition points where icon additions may be attached to the base icon, such as through an icon overlay process. By adding icon additions at the addition points of the base icon, a composite icon is generated and then registered with the graphical user interface.

The icon additions that are used to generate the composite icon are selected based on a particular context in which the object associated with the base icon is being used. By “context” what is meant is the current status or condition of the object taking into account the particular manner in which the object is being used. In preferred embodiments, the context is closely related to the other objects, applications and functions with which the object is being used. Based on the context of the object, its associated base icon is augmented with icon additions appropriate for the context.

The use of icon additions with the base icon is determined dynamically as the context of the corresponding object changes. Thus, for example, if the base icon for the object is selected and dragged over top another base icon associated with another object, thereby instructing that the two objects are to operate together, the context of the objects have changed and thus, one or both of their base icons will be dynamically modified using one or more icon additions determined from context information associated with the objects. In this way, the same base icon may be used to represent a particular object with additions to the base icon being used to provide additional information that is important to the current context of the corresponding object.

In addition to the above, the icon additions according to the present invention are active, i.e. individually selectable. The icon additions are associated with data objects that are accessed when the icon addition is individually selected or when the base icon is selected. In this way, a user may select an icon addition independently of the base icon to perform a function and/or obtain additional information.

These and other feature and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein;

FIG. 1 is an exemplary diagram of known icons in a graphical user interface;

FIG. 2 is an exemplary diagram of a distributed data processing system in which the present invention may be implemented;

FIG. 3 is an exemplary block diagram of a server computing device in accordance with the present invention;

FIG. 4 is an exemplary block diagram of a client computing device in accordance with the present invention;

FIG. 5 is an exemplary diagram illustrating the interaction of the primary elements of the present invention to dynamically build a context sensitive composite icon;

FIG. 6 is an exemplary diagram illustrating a base icon with addition points in accordance with the present invention;

FIG. 7 is an exemplary diagram illustrating a base icon with icon additions added to the base icon based on a context in which the icon is being used;

FIG. 8 is a flowchart outlining an exemplary operation of the present invention;

FIG. 9 is an example of a shopping cart composite icon in accordance with the present invention;

FIG. 10 is an example diagram illustrating the addition of an item to the shopping cart composite icon of FIG. 9; and

FIG. 11 illustrates an exemplary window that may be displayed in response to a user's selection of the base icon in a composite icon.

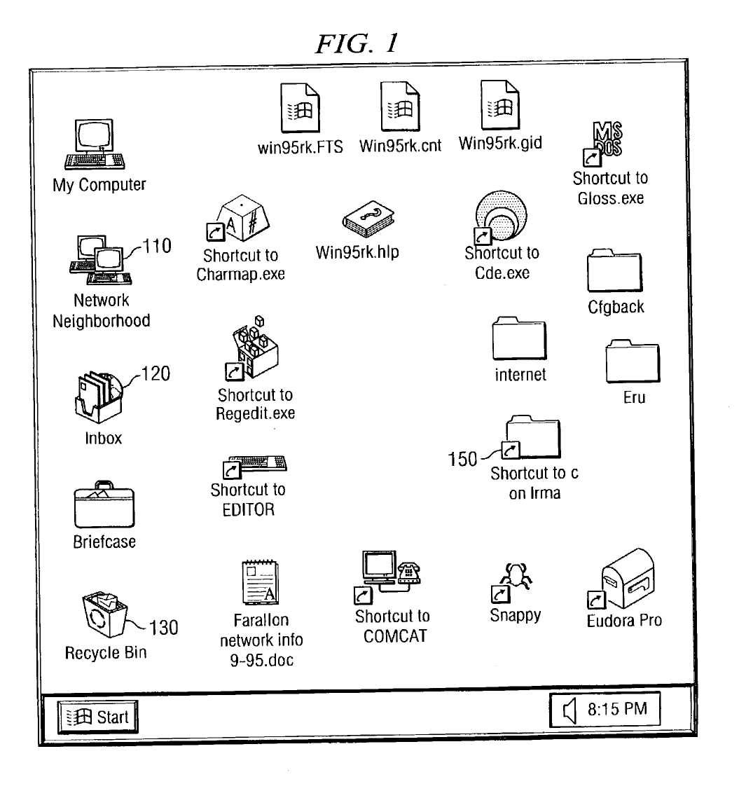

### DETAILED DESCRIPTION OF THE PREFERRED EMBODIMENT

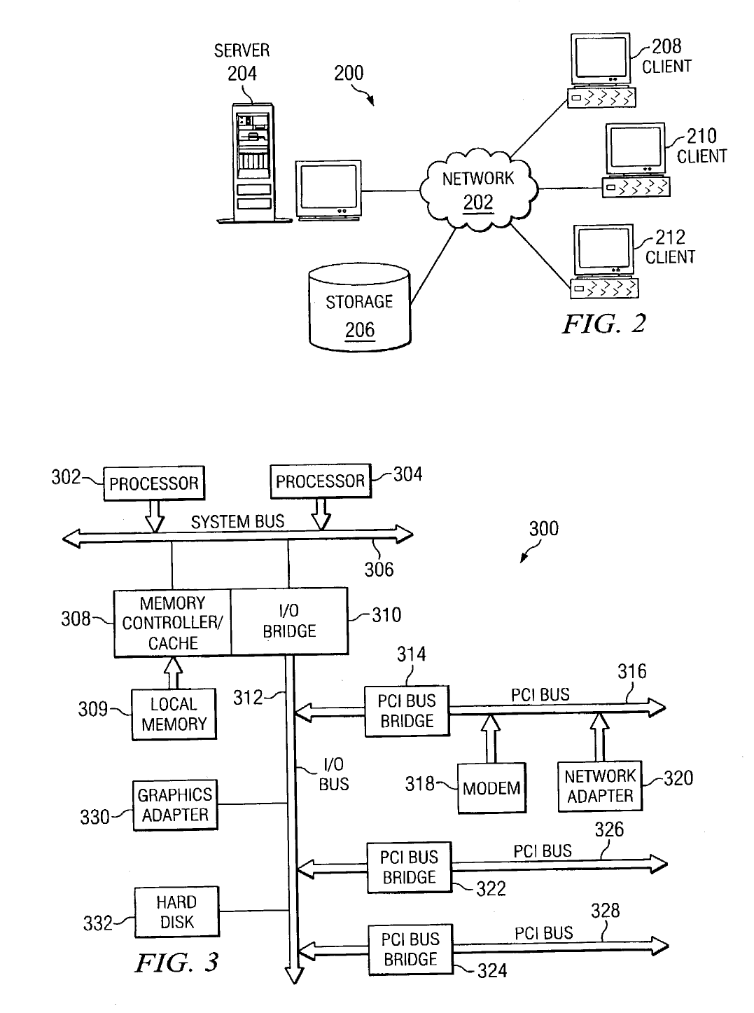

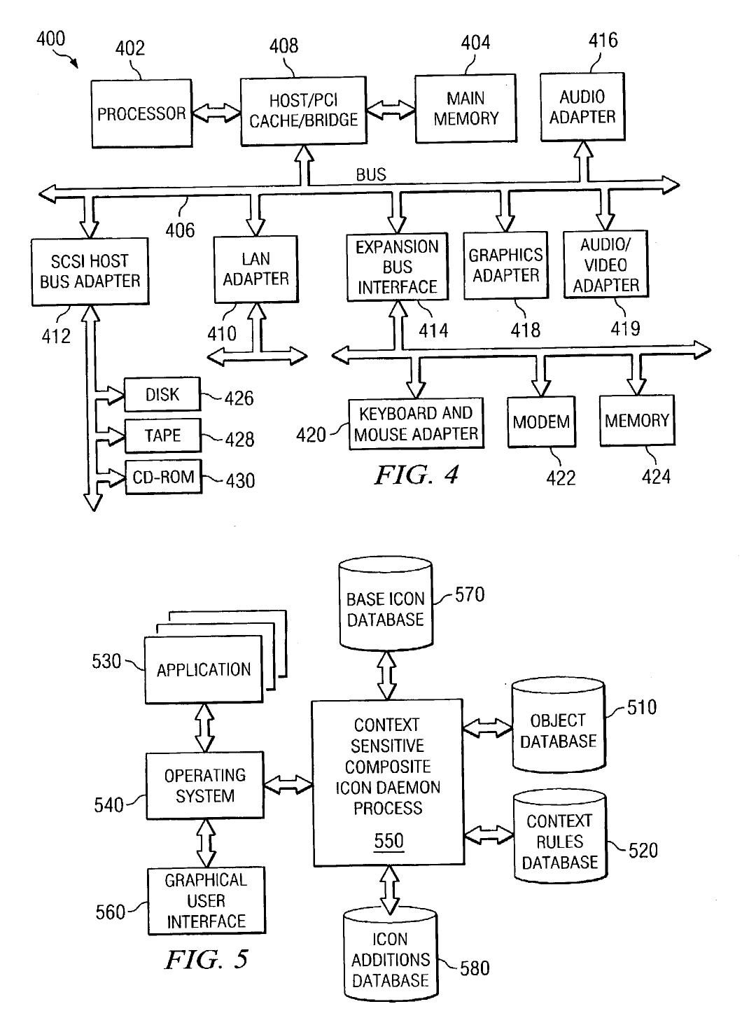

The present invention provides a mechanism for dynamically building context sensitive composite icons. The preferred embodiments of the present invention may be implemented in a stand alone computing device and/or a distributed data processing environment. As such, FIGS. 2-4 are provided hereafter as exemplary of the environment and hardware devices in which the present invention may be implemented. It should be appreciated that in a stand alone computing device, the present invention may be implemented in a computing device such as that shown in FIG. 4 without requiring interaction with a server computing device or network.

With reference now to the figures, FIG. 2 depicts a pictorial representation of a network of data processing systems in which the present invention may be implemented. Network data processing system 200 is a network of computers in which the present invention may be implemented. Network data processing system 200 contains a network 202, which is the medium used to provide communications links between various devices and computers connected together within network data processing system 200. Network 202 may include connections, such as wire, wireless communication links, or fiber optic cables.

In the depicted example, server 204 is connected to network 202 along with storage unit 206. In addition, clients 208, 210, and 212 are connected to network 202. These clients 208, 210, and 212 may be, for example, personal computers or network computers. In the depicted example, server 204 provides data, such as boot files, operating system images, and applications to clients 208-212. Clients 208, 210, and 212 are clients to server 204. Network data processing system 200 may include additional servers, clients, and other devices not shown.

In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

Referring to FIG. 3, a block diagram of a data processing system that may be implemented as a server, such as server 204 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed.

Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to clients 208-212 in FIG. 2 may be provided through modem 318 and network adapter 320 connected to PCI local bus 316 through add-in boards. Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pSeries system, a product of International Business Machines Corporation in Armonk, N.Y., running the Advanced Interactive Executive (AIX) operating system or LINUX operating system.

With reference now to FIG. 4, a block diagram illustrating a data processing system is depicted in which the present invention may be implemented. Data processing system 400 is an example of a client computer. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. Expansion bus interface 414 provides a connection for a keyboard and mouse adapter 420, modem 422, and additional memory 424. Small computer system interface (SCSI) host bus adapter 412 provides a connection for hard disk drive 426, tape drive 428, and CD-ROM drive 430. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows XP, which is available from Microsoft Corporation. An object oriented programming system such as Java may run in conjunction with the operating system and provide calls to the operating system from Java programs or applications executing on data processing system 400. “Java” is a trademark of Sun Microsystems, Inc. Instructions for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash read-only memory (ROM), equivalent nonvolatile memory, or optical disk drives and the like, may be used in addition to or in place of the hardware depicted in FIG. 4. Also, the processes of the present invention may be applied to a multiprocessor data processing system.

As another example, data processing system 400 may be a stand-alone system configured to be bootable without relying on some type of network communication interfaces As a further example, data processing system 400 may be a personal digital assistant (PDA) device, which is configured with ROM and/or flash ROM in order to provide non-volatile memory for storing operating system files and/or user-generated data.

The depicted example in FIG. 4 and above-described examples are not meant to imply architectural limitations. For example, data processing system 400 also may be a notebook computer or hand held computer in addition to taking the form of a PDA. Data processing system 400 also may be a kiosk or a Web appliance.

As mentioned previously, the present invention provides a mechanism for dynamically building a context sensitive composite icon with active icon components. With the present invention, a base icon is used to represent a particular object in a graphical user interface. This base icon has addition points where icon additions may be attached to the base icon, such as through an icon overlay process. By adding icon additions at the addition points of the base icon, a composite icon is generated and then registered with the graphical user interface. The icon additions that are used to generate the composite icon are dynamically selected based on a particular context in which the object associated with the base icon is being used.

FIG. 5 is an exemplary diagram illustrating the interaction of the primary elements of the present invention to dynamically build a context sensitive composite icon. As shown in FIG. 5, an object database 510 and context rules database 520 are provided for storing data that is used by a context sensitive composite icon daemon process 550. The context sensitive composite icon daemon process 550 operates in the background of the graphical user interface 560 such that the functions it performs are not readily discernible by the user of the graphical user interface 560.

The context sensitive composite icon daemon process 550 is responsible for dynamically generating composite icons, in accordance with the present invention, based on the context of the objects associated with the icons. The context sensitive composite icon daemon process 550 (hereafter referred to as the daemon process 550), listens for events from the graphical user interface 560 and applications 530. The operating system 540 is provided with event handlers and event notification mechanisms as is known in the art. The daemon process 550 registers with these event handlers and notification mechanisms as a listener of events and thus, when the graphical user interface 560 or the applications 530 generate events that are of interest to the daemon process 550, the daemon process 550 is notified and provided with the necessary information to perform the tasks of the present invention.

The events represent operations being performed on objects stored in the object database 510. The events include information identifying the particular objects of object database 510 involved in the event, the particular application, the functions being performed, and the like.

For example, an event may be the selection of an icon using the graphical user interface (GUI) 560, dragging a selected icon over top another icon in the GUI 560, initialization of an application 530, performing a function in an application 530, creation of a new object in the object database 510, and the like. The number of possible events that may be handled by the present invention precludes the mentioning of each herein. Those of ordinary skill in the art, however, will understand the scope of events that may be used with the present invention in view of the present description of the exemplary embodiments.

Based on the event notification received, the daemon process 550 retrieves information regarding the objects from the object database 510 that are involved in the event. In addition, from the information stored in the event notification, e.g., name of the application issuing the event notification, the function being performed, the particular objects involved, etc. a context of the objects is determined. For example, from the event notification, a determination may be made that an object representing a patient is being added to a patient monitoring application 530.

Based on this determination, context rules for that particular application 530 are retrieved from the context rules database 520 and applied to the objects retrieved from object database 510. By applying the context rules to the object, it can be determined which icon additions are to be displayed with the base icon representing the object for representing the object in the particular context.

For example, in the example given above, if the application is a patient monitoring application, the relevant information associated with the object that is of importance in such a context is the type of injury or ailment of the patient, the current status of the patient, the name of the patient, and the present location of the patient. The context rules for such an example may be of the type: retrieve patient name, retrieve patient ailment, retrieve current status, retrieve present location, if injury is “cardiac” display icon addition “heart” at addition point 1, if injury is “car accident” display icon addition “car” at addition point 1, etc.

Thus, the context determination information obtained from the event is used to select a set of rules for the particular context. The context rules determine what information to extract from the object associated with the base icon for the particular context, what icon addition to display with the base icon based on the information extracted from the object, and where to display the icon addition.

Once it is determined which icon additions are to be displayed with the base icon based on the current context of the object and where on the base icon the additions are to be placed, the daemon process 550 retrieves the information for the base icon from the base icon database 570 and information for the icon additions from the icon additions database 580. The daemon process 550 then generates a composite icon data file representing the composite of the base icon and the icon additions placed at the designated additions points of the base icon. The daemon process 550 then registers the composite icon with the operating system 540 which causes the composite icon to be displayed, or “painted”, in the graphical user interface 560.

The base icon database 570 and icon additions database 580 may be associated with the operating system 540, the graphical user interface 560, or one or more of the applications 530. For example, the base icon database 570 may be associated with the graphical user interface 560 while the icon additions database 580 is specifically designed and associated with a particular one of the applications 530. Alternatively, a standardized database of base icons and icon additions may be stored in a local or remote location with base icons and icon additions being retrieved on an as needed basis. Of course, other mechanisms for storing the base icons and icon additions may be used without departing from the present invention so long as they are accessible by the context sensitive composite icon daemon process 550.

Thus, through event notification, the daemon process 550 is dynamically informed of changes to context of objects in the object database 510. Based on this dynamic notification of context changes, the daemon process 510 retrieves rules 520 and applies them to generate a context sensitive composite icon that is a composite of the base icon for the object and icon additions selected based on the context and the particular attributes of the object.

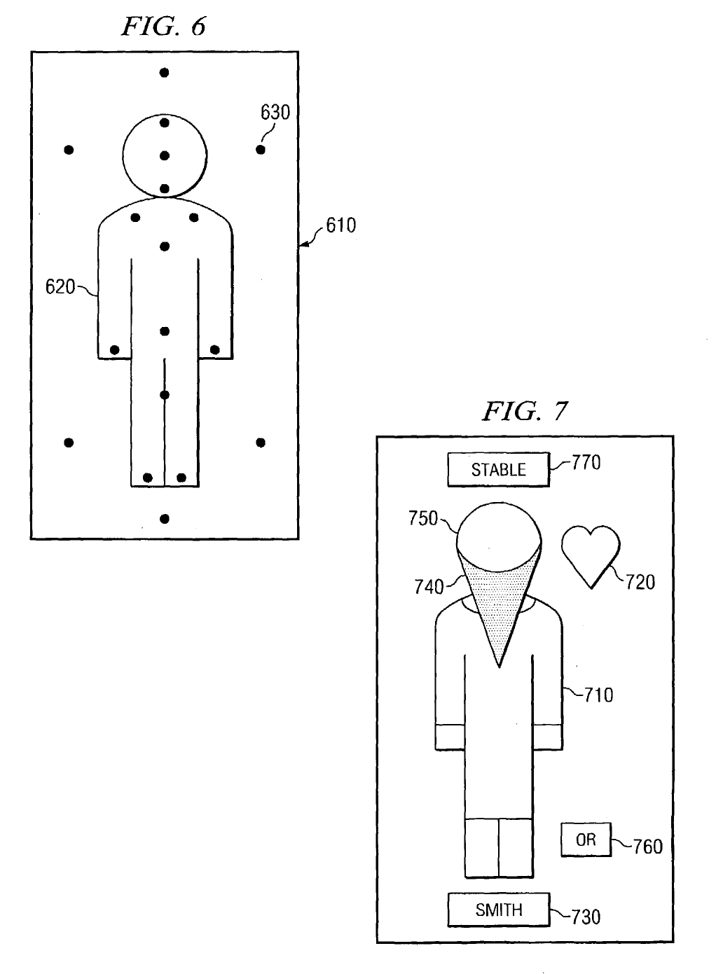

FIG. 6 is an exemplary diagram illustrating a base icon with addition points in accordance with the present invention. As shown in FIG. 6, the graphical depiction 620 of icon 610 represents a male person. The dark dots 630 on the icon 610 represent addition points where icon additions may be placed based on the context of the object associated with the icon 610. While these addition points 630 are shown as dark visible dots in FIG. 6, in actuality when the icon 610 is displayed in a GUI, such as GUI 560, the addition points are not visible, The addition points 630 only exist in terms of the data representation of the icon 610.

In a preferred embodiment, the addition points 630 are placed at standardized positions of the icon 610. That is, the addition points 630 are at the same position in each of icon of the type shown in FIG. 6 regardless of the particular source of the icon. In this way, icons from different sources may be used with the same set of icon additions without having compatibility problems when creating the composite icons.

The base icon 610 is an icon that may be used to represent the same object in a number of different contexts. In this way, there is a uniformity of representation of the object in each context that allows a user to develop a recognition of the icon as being associated with a particular object. For example, a user may generate an object that represents himself, e.g., by using an application to enter information about himself, and then select a base icon to represent the object he created. This is typically done when a user registers with a communications application, such as a newsgroup, chat room, etc. Since this base icon will retain much of its characteristics regardless of what context it is used in, the user will be able to immediately recognize the icon as representing “himself,” i.e. the object created to store the data about the user.

However, the base icon 610 of the present invention is provided with addition points 620 which may be used to add icon additions to display additional information about the object based on the particular context. For example, if the user has a particular role in a certain newsgroup, has been a member of the newsgroup for a period of time, etc., icon additions representing this information may be selected for display at addition points in the base icon when the object representing the user is used with the newsgroup application. For example, a background of the base icon may be changed to represent a particular newsgroup, a beard may be added to the icon representing the user to designate that the user has been part of the newsgroup for a long period of time, and a hat may be added to the base icon to represent that the user has a particular role in the newsgroup. Thus, even though the composite icon will retain much of the base icon 610 for recognition purposes, additional information about the object associated with the base icon 610, that is pertinent to the present context, is displayed through the use of the addition points and icon additions.

FIG. 7 is an exemplary diagram illustrating a base icon with icon additions added to the base icon based on a context in which the icon is being used. In the particular example shown in FIG. 7, the object associated with the base icon 610 in FIG. 6 has been used with an application for monitoring patient status. As a result, the information obtained from the object pertains to the status of the patient represented by the object. Likewise, the particular graphical icon additions selected based on this patient status information extracted from the object are selected from a set of graphical icon additions representing patient status attributes.

For example, assume that the object associated with icon 610 represents a male person, Mr. Smith. The object may have the following list of attributes:

Last Name—Smith

Type—Patient

Gender—Male

Age—69

Ailment—Cardiac

Current Location—Operating Room

Current Condition—Stable

Upon the creation of the object for Mr. Smith in a computing system, the daemon process of the present invention may generate the base icon shown in FIG. 6. This base icon may be generated based on the fact that Mr. Smith is male and thus, a male base icon is selected to represent Mr. Smith. Additions to this base icon are then selected based on the fact that the object is to be used with the patient status monitoring application.

As a result that the object is being used with the patient status monitoring application, which may be determined based on an event such as refreshing the patient status monitoring application or updating it at predetermined selected times, a set of context rules is retrieved from a context rules database for the patient status monitoring application. These context rules are then applied to the object representing Mr. Smith to thereby extract the above attribute information from the object and use it with the context rules to determine how to represent the icon for Mr. Smith in the graphical user interface associated with the patient monitoring application.

FIG. 7 illustrates the results of applying the context rules to the attribute information extracted from the object representing Mr. Smith. As shown in FIG. 7, based on the fact that Mr. Smith's type is “patient” a patient robe icon addition is added to addition points over male body graphic 750 in the base icon 610. In a color representation of the icon, this patient robe may be green in color to resemble actual patient robes often found in hospital environments.

A heart icon addition 720 is added to the icon 610 in order to indicate that Mr. Smith is a cardiac patient. A banner icon addition 730 with the text “Smith” is added to represent Mr. Smith's last name in the composite icon. A beard icon addition 740 is added to the body graphic 750 to represent the age of Mr. Smith. A banner icon addition 760 is added to indicate the current location of Mr. Smith being in the operating room, or “OR”. Lastly, a banner icon addition 770 is added with the text “Stable” to indicate Mr. Smith's current condition. The result of the base icon and the icon additions shown in FIG. 7 is then stored as a composite icon which is registered with the operating system for use with the patient status monitoring application. The composite icon may then be displayed and may be selectable for use in the patient status monitoring application.

The addition of the icon additions to the base icon at the addition points may be performed by superimposing the icon additions on the base icon. Such superimposing may be performed using an icon overlay approach, such as is known in the art, which is modified to be able to overlay the icon additions of the present invention at various established addition points on the base icon. Alternatively, graphical elements of the base icon may be directly modified to thereby “insert” the icon additions into the base icon to generate a composite icon.

Moreover, bit masking across the image may be used to add icon additions to the base icon at the addition points. Bit masking is generally known in the art but has not been used with regard to a composite icon such as that taught in the present invention.

In the happenstance that two or more icon additions are to be added at the same addition point, a priority mechanism similar to that discussed above with regard to icon overlays may be used to determine which icon addition to add to the base icon. Alternatively, other alternate addition points may be selected for adding icon additions that would otherwise be added to the same addition point in the base icon.

In yet other embodiments of the present invention, if a conflict arises between icon additions, the conflict itself may be used as a way to notify a user of an error or potentially dangerous condition. For example, if the base icon is an airplane and two icon additions are attempting to be added to the base icon that conflict with one another, the conflict may be used as a mechanism for notifying the pilot or other user of a potentially dangerous condition. That is, if one icon addition is an addition to indicate that the flaps are being deployed and the second icon addition is an addition to indication that the flaps are being retracted, these two icon additions conflict with one another and could cause a potential problem with operation of the aircraft. Upon detection of the conflicting icon additions, a notification may be made to the user indicating the conflict and allowing the user to determine how to solve the conflict, such as by taking over manual control of the aircraft.

In another example, using the hospital patient examples discussed previously, if an icon addition illustrates that medications have been provided to the patient and another icon addition is attempted to be added to the composite icon indicating that medications have been administered, the attempt to add another icon addition is an indication that the patient may have received a double dose of medication. Based on this conflict, a notification may be provided to hospital personnel in order to let them take appropriate measures to assure the health of the patient.

It should be appreciated that the same base icon shown in FIG. 6 may be used with many different applications and many different contexts. Thus, while FIG. 7 illustrates one possible composite icon generated from the base icon, in other contexts the composite icon will look different. For example, if the same base icon is used in a newsgroup application, the corresponding composite icon will not include icon additions representing current patient status. Rather, the composite icon will have icon additions added to addition points of the base icon that are appropriate for the newsgroup application.

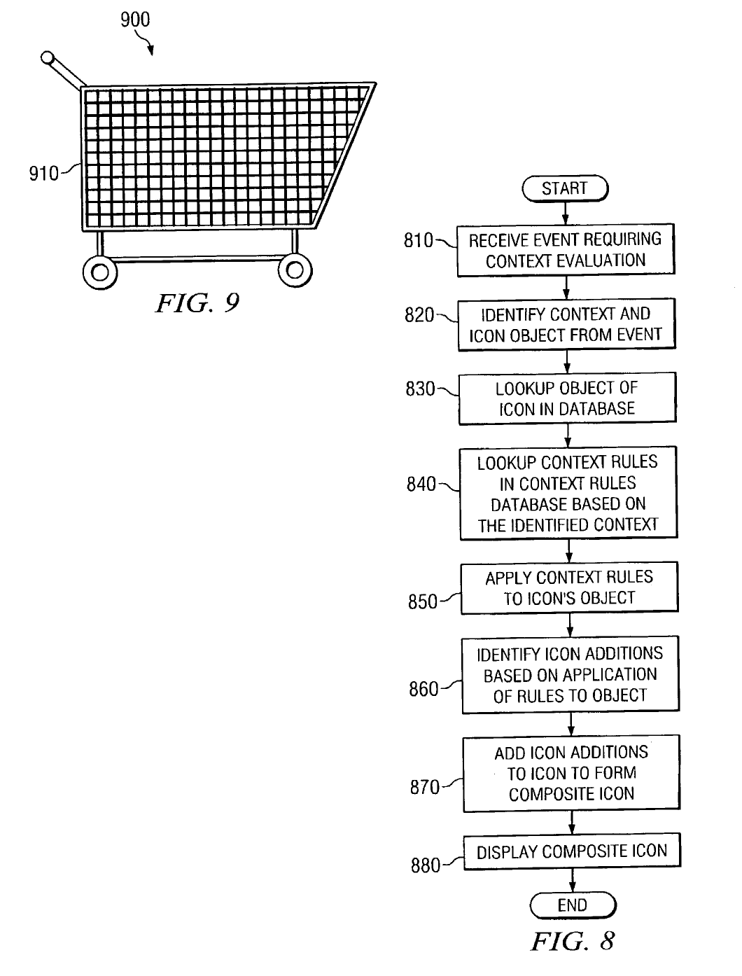

FIG. 8 is a flowchart outlining an exemplary operation of the present invention. As shown in FIG. 8, the operation starts with receiving an event requiring context evaluation for one or more objects of a computing system (step 810). The context and icon object are identified from information obtained from the event (step 820). The object of the base icon is looked up in the object database (step 830) and the context rules in the context rules database are retrieved (step 840). The context rules are then applied to the icon's object (step 850). Icon additions are then identified based on the application of the context rules to the object (step 860) and the icon additions are added to the addition points of the base icon to form a composite icon (step 870). The composite icon is then displayed (step 880) and may be used in the graphical user interface.

The icon additions mentioned previously, in accordance with a preferred embodiment of the present invention, are active icon additions. By “active” what is meant is that the icon additions may themselves be selectable using a pointing device associated with the computing device in which the base icons and icon additions are used. By selecting the active icon additions, additional information about the icon additions or further functionality may be obtained.

For example, a base icon may represent a shopping cart object for a particular user of an on-line shopping web site. As the user adds item objects for purchase to their shopping cart object, representations of these objects may be dynamically added to the base icon as active icon additions. These active icon additions may be individually selectable such that the user may obtain information regarding the particular item objects without having to display information regarding the entire contents of the shopping cart object.

Referring again to FIG. 5, when an event occurs that requires the generation of a composite icon, such as an application 530 performing a function that results in a composite icon being generated, two or more objects in the object database 510 being used with one another, or the like, the context sensitive composite icon daemon process 550 operates to create the composite icon in the manner previously described. The events may cause objects to be created and associated with icon additions that are to be added to a base icon to form a composite icon. Alternatively, the icon additions may initially have associated objects that may be accessed through selection of the icon addition in the composite icon.

In other words, with the present invention, icon addition objects may be associated with the icon additions in the icon additions database 580 such that individual selection of the icon addition invokes the icon addition object associated with it. The active icon addition according to the present invention is superimposed over the base icon at one or more positions corresponding to the addition points described earlier. By superimposing the icon addition over the icon base, the icon addition is provided as a separately selectable entity in the composite icon. The particular icon additions used and the manner in which they are used to generation the composite icon is determined based on the context rules in the context rules database 520.

With the active icon addition embodiments of the present invention, the composite icon is represented as a data object that defines the base icon and contains references to icons for icon additions that are included in the composite icon. The references to the icon additions identify the icon for the icon additions and their placement with regard to the base icon in the composite icon. Thus, the composite icon with regard to these embodiments is a collection of individual icons that are superimposed over the base icon. Since the icon additions are not inserted into the base icon or otherwise integrated with the base icon, and the icon additions are individual icons associated with icon addition objects, the icon additions remain individually selectable by a user.

When a user selects an icon addition of a composite icon the object associated with the icon addition in the object database 510 is invoked in a manner similar to that known in the art. That is, just as icons are selectable in known graphical user interfaces, the icon additions of the present invention are likewise selectable to perform functions and/or provide information. One of the primary differences between known icons and the icon additions of the present invention is that the icon additions are used in combination with a base icon to generate a composite icon that represents a combination of the base icon and the icon additions. These icon additions may be added to a base icon in response to events occurring and the context in which such events occur. Furthermore, these icon additions may be added at standardized addition points present in the base icon.

To illustrate the manner by which active icon additions are added to a base icon, FIG. 9 is provided as an example of a shopping cart composite icon. The shopping cart composite icon 900 is comprised of a base icon 910 that may be generated in response to a function being performed, for example, based on interaction between a user of a computing device and a web site hosted by a server. The user may select to purchase an item from an on-line catalog of the web site or may be created in response to the user providing personal information regarding the user to the web site, for example.

As the user selects items from the on-line catalog for purchase, events are generated for adding the items to the user's shopping cart object associated with the shopping cart composite icon 900. Thus, in this case, the function of selecting an item and choosing “Add to Cart”, for example, causes an event to be generated that identifies the item object that is to be added to the composite shopping cart object with the context being selection of the object for purchase.

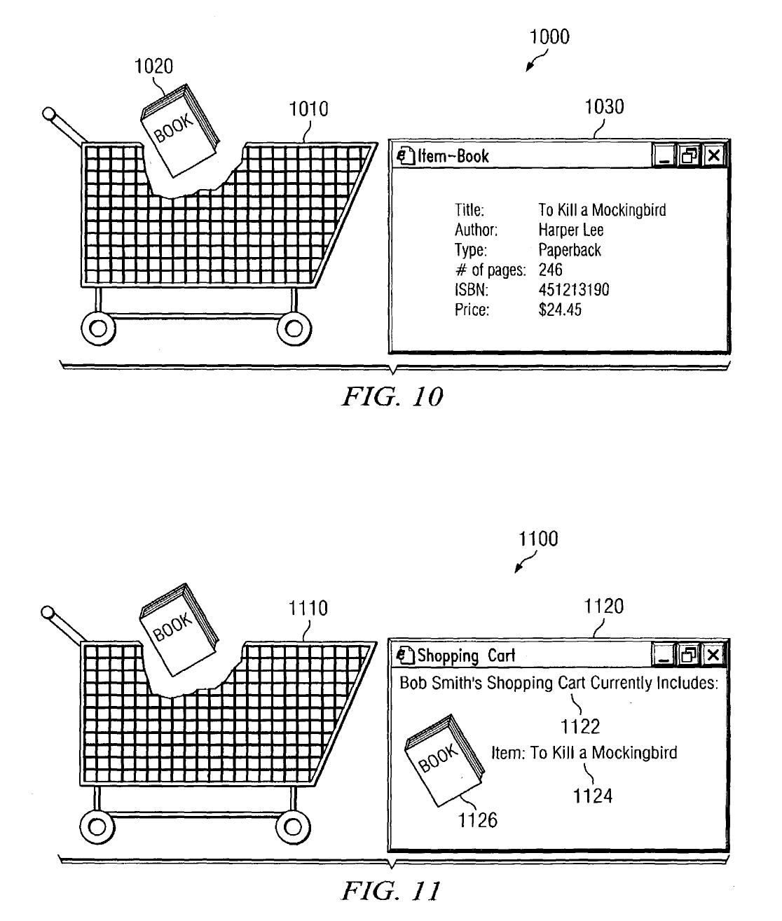

As in the previous embodiments discussed above, the events generated by the web site in response to the user's interaction are provided to the context sensitive composite icon daemon process which has registered as a listener for such events. The context sensitive composite icon daemon process identifies the item object, shopping cart object, and context, i.e. add the item object to the shopping cart object, and generates a composite icon in accordance with the context rules retrieved from the context rules database 520 based on the identified context in the received event. The composite icon is generated by superimposing an icon addition associated with the item object over the shopping cart base icon. This is illustrated in FIG. 10.

As shown in FIG. 10, the user has selected a book for purchase via the web site. As a consequence of this selection, the book icon addition 1020 is added to the shopping cart base icon 1010 to thereby generate a composite icon 1000.

The book icon addition 1020 is individually selectable in order to obtain additional information about the item object associated with the book icon addition. That is, in response to selecting the book icon addition 1020, the user is provided with the window 1030 that includes information about the book including the title, author, number of pages, whether the book is paperback or hardcover, the ISBN for the book, etc.

The adding of icon additions 1020 for items selected for purchase may continue with each new icon addition being added at a respective one of the addition points of the base icon 1010. Again, as noted above, if there are conflicts between icon additions, one of the above mechanisms may be used to determine how to display the icon additions as part of the composite icon 1000.

It should be noted that both the icon additions and the base icon are individually selectable. When the icon additions are individually selected by a user, the associated icon addition object is invoked in order to perform an associated function and/or provide information regarding the icon addition object. However, if the base icon is selected, the associated composite icon object is invoked to perform some associated function and/or provide information regarding the composite icon. Such information may include information about each icon addition that was added to the composite icon.

FIG. 11 illustrates an exemplary window 1120 that may be displayed in response to a user's selection of the base icon 1110 in a composite icon 1100. As shown in FIG. 11, the window 1120 includes identification information 1122 identifying the user to which the shopping cart belongs and information regarding the items 1124 that have been added to the shopping cart composite object. The items listed in the window 1120 may have the associated icon addition presented with the item in the list and thus, may be selectable from the window to obtain additional functionality and/or information regarding the item.

Thus, with the present invention, active icon additions are added to a base icon based on the context in which the base icon is being used. These active icon additions are individually selectable to allow a user to obtain additional functionality and/or information regarding the icon addition object associated with the icon addition.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for dynamically building a context sensitive composite icon for representing a data object in a graphical user interface, comprising:
identifying a data object;
identifying an icon addition data object based on a context of the data object;
generating a composite icon object based on the data object and the icon addition data object;
generating a graphical representation of a base icon based on the data object;
generating a graphical representation of the icon addition data object; and
superimposing the graphical representation of the icon addition data object over the graphical representation of the base icon, wherein the graphical representation of the icon addition data object and the graphical representation of the base icon are individually selectable.

2. The method of claim 1, wherein the data object is a shopping cart data object.

3. The method of claim 2, wherein the icon addition data object is a item selected for purchase.

4. The method of claim 1, further comprising:
receiving an event notification indicating a change in context for the data object, wherein the steps of identifying, generating and superimposing are performed in response to receiving the event notification.

5. The method of claim 1, further comprising:
receiving an event notification identifying the data object, the icon addition data object, and an operation being performed with regard to the data object and icon addition data object;
identifying the context of the data object based on the identification of the data object, identification of the icon addition data object, and the operation being performed with regard to the data object and the icon addition data object;
retrieving one or more context rules associated with the context of the data object; and
applying the context rules to the data object to thereby identify the icon addition to be added to the base icon.

6. The method of claim 1, further comprising:
receiving a user input that selects the icon addition; and
invoking the icon addition data object in response to receiving the user input.

7. The method of claim 6, wherein invoking the icon addition data object results in performing a function on the data object associated with the base icon.

8. The method of claim 6, wherein invoking the icon addition data object results in obtaining information about the icon addition data object.

9. The method of claim 1, further comprising:
receiving a user input that selects the base icon; and
invoking the composite icon object in response to receiving the user input.

10. The method of claim 1, wherein the composite icon object includes a reference to the data object and to the icon addition data object.

11. A computer program product in a computer readable medium for dynamically building a context sensitive composite icon for representing a data object in a graphical user interface, comprising:
first instructions for identifying a data object;
second instructions for identifying an icon addition data object based on a context of the data object;
third instructions for generating a composite icon object based on the data object and the icon addition data object;
fourth instructions for generating a graphical representation of a base icon based on the data object;
fifth instructions for generating a graphical representation of the icon addition data object; and
sixth instructions for superimposing the graphical representation of the icon addition data object over the graphical representation of the base icon, wherein the graphical representation of the icon addition data object and the graphical representation of the base icon are individually selectable.

12. The computer program product of claim 11, wherein the data object is a shopping cart data object.

13. The computer program product of claim 12, wherein the icon addition data object is a item selected for purchase.

14. The computer program product of claim 11, further comprising:
seventh instructions for receiving an event notification indicating a change in context for the data object, wherein the steps of identifying, generating and superimposing are performed in response to receiving the event notification.

15. The computer program product of claim 11, further comprising:
seventh instructions for receiving an event notification identifying the data object, the icon addition data object, and an operation being performed with regard to the data object and icon addition data object;
eighth instructions for identifying the context of the data object based on the identification of the data object, identification of the icon addition data object, and the operation being performed with regard to the data object and the icon addition data object;
ninth instructions for retrieving one or more context rules associated with the context of the data object; and
tenth instructions for applying the context rules to the data object to thereby identify the icon addition to be added to the base icon.

16. The computer program product of claim 11, further comprising:
seventh instructions for receiving a user input that selects the icon addition; and
eighth instructions for invoking the icon addition data object in response to receiving the user input.

17. The computer program product of claim 16, wherein the eighth instructions for invoking the icon addition data object results in performing a function on the data object associated with the base icon.

18. The computer program product of claim 16, wherein the eighth instructions for invoking the icon addition data object results in obtaining information about the icon addition data object.

19. The computer program product of claim 11, further comprising:
seventh instructions for receiving a user input that selects the base icon; and
eighth instructions for invoking the composite icon object in response to receiving the user input.

20. The computer program product of claim 11, wherein the composite icon object includes a reference to the data object and to the icon addition data object.

21. An apparatus for dynamically building a context sensitive composite icon for representing a data object in a graphical user interface, comprising:
means for identifying a data object;
means for identifying an icon addition data object based on a context of the data object;
means for generating a composite icon object based on the data object and the icon addition data object;
means for generating a graphical representation of a base icon based on the data object;
means for generating a graphical representation of the icon addition data object; and
means for superimposing the graphical representation of the icon addition data object over the graphical representation of the base icon, wherein the graphical representation of the icon addition data object and the graphical representation of the base icon are individually selectable.
